(19) United States
(12) Patent Application Publication
(10) Pub. No.: US 2014/0089713 A1
(43) Pub. Date: Mar. 27, 2014

(54) COMPUTER SYSTEM, POWER SUPPLY DEVICE AND METHOD THEREOF

(71) Applicant: WISTRON CORPORATION, New Taipei City (TW)

(72) Inventors: Chun-Lung Hsiao, New Taipei City (TW); Yao-Hsien Chang, New Taipei City (TW)

(73) Assignee: WISTRON CORPORATION, New Taipei City (TW)

(21) Appl. No.: 13/691,853

(22) Filed: Dec. 3, 2012

(30) Foreign Application Priority Data
Sep. 27, 2012 (TW) 101135516

(51) Int. Cl. G06F 1/32; G06F 1/26

(52) U.S. Cl. CPC G06F 1/3234; G06F 1/26
USPC 713/324; 713/300

(57) ABSTRACT

A computer system includes a first electronic device configured to be operated by utilizing a regular voltage, a second electronic device configured to be operated by utilizing the regular voltage, and a power supply device for providing the regular voltage. The power supply device includes a voltage regulator coupled to the first electronic device for transforming a supply voltage to output the regular voltage to the first electronic device, a control logic circuit for generating an enable signal according to a control signal, and a load switch circuit coupled to the control logic circuit, the voltage regulator and the second electronic device for outputting the regular voltage to the second electronic device according to the enable signal.

### BACKGROUND OF THE INVENTION

1. Field of the Invention

The present invention relates to a computer system, a power supply device and related method, and more particularly, to a computer system, a power supply device and related method capable of saving cost and reducing power consumption.

2. Description of the Prior Art

When the computer system performs operations, a main memory module is usually required for temporarily storing data, instructions and programs. Meanwhile, a graphics card module is also required to transform messages, which are ready to be displayed by the computer system, to drive a display, so as to enhance the performance of the computer system. Besides, the main memory module and the graphics card module require power to be able to operate, and the working voltage of the main memory module and the graphics card module are lower and lower with a more and more state-of-the-art wafer process. For example, today's main memory module, like Small Outline-Dual In-Line Memory Module (SO-DIMM), is mainly configured as a Double-Data-Rate Three Synchronous Dynamic random Access memory (DDR3 SDRAM) due to the capacity, performance, and price considerations. The types and related working voltages of the DDR3 SDRAM can be subdivided as DDR3, DDR3L (Low-Voltage DDR3) and DDR3U (Ultra Low-Voltage DDR3), and the corresponding working voltages are 1.5V, 1.35V and 1.25V. Additionally, in order to increase the performance of playing video and reduce the workload of the CPU, the graphics card module is usually configured as a Video Random Access Memory (VRAM). The VRAM is a dual-port memory, that is, there are two access ports, one of which is used to continuously update the displaying data, and the other is used to change the data which will be displayed. In comparison with the main memory modules, there are many common types of VRAM that can be configured in the graphics card, and usually are selected depending on the different levels of the graphics card module, for example Graphics Double Data Rate-Synchronous Graphics Random Access Memory (GDDR-SGRAM), DDR3, or etc.

In general, in the computer system, the main memory module and the graphics card module are configured exclusive voltage regulators for the required operating power. Please refer to FIG. 1, which illustrates a schematic diagram of a conventional computer system 10. As shown in FIG. 1, the computer system 10 utilizes voltage regulators 100, 102 to transform a supply voltage VS, which is provided by a power supply, to a regular voltage VR1 required for a main memory module 104 and a regular voltage VR2 required for a graphics card module 106, so as to achieve the requirement of the different required voltages for the two modules. However, the voltage regulator is very expensive, and if every electronic device is configured with exclusive voltage regulators for the required operating power, the cost and the power consumption will be high. Thus, there is a need for improvement of the prior art.

### SUMMARY OF THE INVENTION

It is therefore an objective of the present invention to provide a computer system, a power supply device and related method, capable of saving cost and reducing power consumption.

An embodiment of the invention discloses a computer system. The computer system comprises a first electronic device, configured to be operated by utilizing a regular voltage, a second electronic device configured to be operated by utilizing the regular voltage, and a power supply device for providing the regular voltage. The power supply device comprises a voltage regulator coupled to the first electronic device for transforming a supply voltage to output the regular voltage to the first electronic device, a control logic circuit for generating an enable signal according to a control signal, and a load switch circuit coupled to the control logic circuit, the voltage regulator, and the second electronic device for outputting the regular voltage to the second electronic device according to the enable signal.

An embodiment of the invention further discloses a power supply device, for a computer system. The power supply device comprises a voltage regulator for transforming a supply voltage to output a regular voltage to a first electronic device of the computer system, a control logic circuit for generating an enable signal according to a control signal, and a load switch circuit coupled to the control logic circuit, the voltage regulator, and a second electronic device of the computer system for outputting the regular voltage to the second electronic device according to the enable signal.

An embodiment of the invention further discloses a power supply method for a computer system, wherein the computer system comprises a first electronic device and a second electronic device. The power supply method comprises transforming a supply voltage to output a regular voltage to a first electronic device of the computer system, generating an enable signal according to a control signal, and outputting the regular voltage to the second electronic device according to the enable signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional computer system.

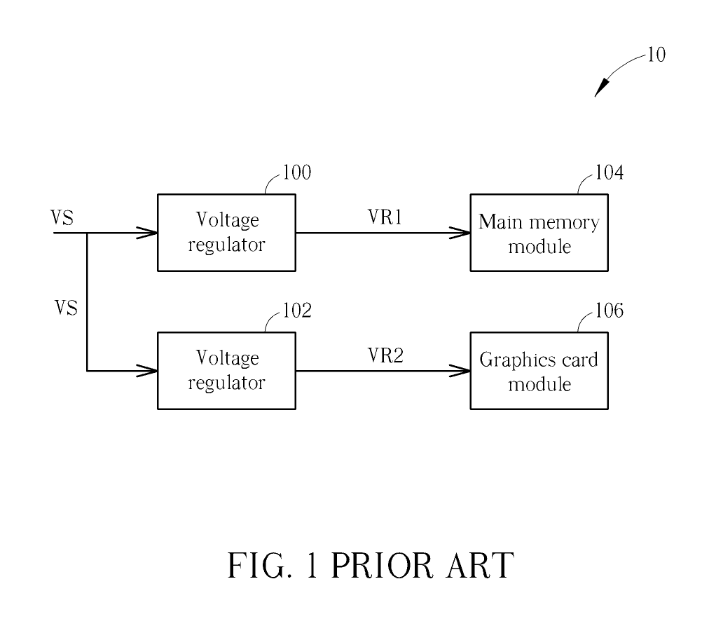

FIG. 2 illustrates a schematic diagram of a computer system according to an embodiment of the invention.

FIG. 3 illustrates a schematic diagram of a power supply process according to an embodiment of the invention.

### DETAILED DESCRIPTION

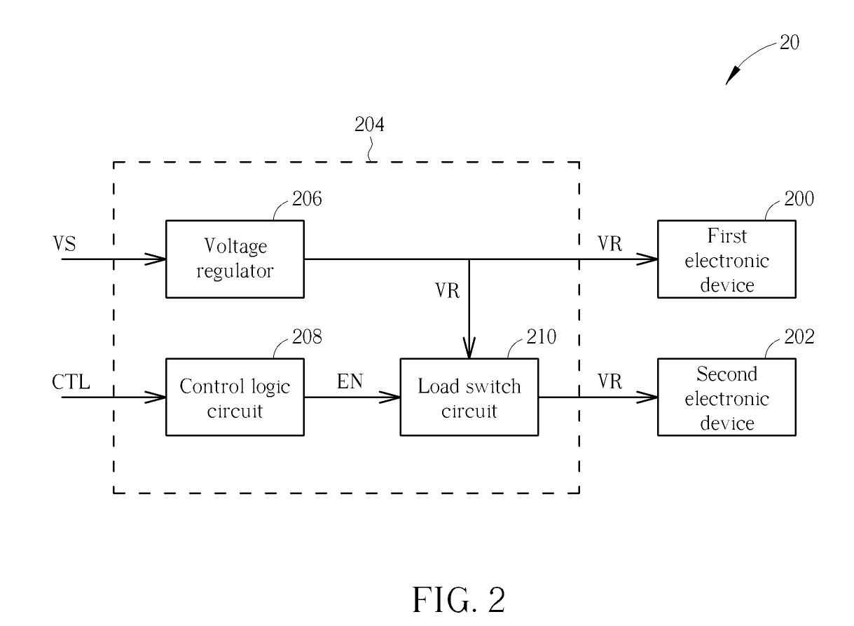

Please refer to FIG. 2, which illustrates a schematic diagram of a computer system 20 according to an embodiment of the invention. The computer system 20 includes a first electronic device 200, a second electronic device 202, and a power supply device 204. The power supply device 204 includes a voltage regulator 206, a control logic circuit 208, and a load switch circuit 210, to provide a regular voltage VR to the first electronic device 200 and the second electronic device 202 for performing operations. The detailed architecture and connection of the power supply device 204 are shown in FIG. 2. The voltage regulator 206 is coupled to the first electronic device 200 for transforming a supply voltage VS to output the regular voltage VR to the first electronic device 200. The control logic circuit 208 is utilized for generating an enable signal EN according to a control signal CTL. The load switch circuit 210 is coupled to the control logic circuit 208, the voltage regulator 206, and the second electronic device 202, for outputting the regular voltage VR to the second electronic device 202 according to the enable signal EN. In other words, by the operations of the control logic circuit 208 and the load switch circuit 210, in addition to providing the regular voltage VR to the first electronic device 200, the power supply device 204 also provides the regular voltage VR to the second electronic device 202. That is, the required regular voltage may be provided to a plurality of electronic devices through a single voltage regulator, and the system cost and power consumption can be effectively reduced.

In an embodiment of the present invention, the first electronic device 200 is a Small Outline-Dual In-Line Memory Module (SO-DIMM) using a Double-Data-Rate Three (DDR3) specification and a related working voltage is 1.5V, and the second electronic device 202 is a graphics card module using a Graphics Double Data Rate-Synchronous version 5 (GDDR5) specification and a related working voltage is 1.5V. The voltage regulator 206 transforms the supply voltage VS provided by the power supply to the regular voltage VR, and outputs the regular voltage VR to the first electronic device 200 for operating the first electronic device 200. When the voltage specification of the SO-DIMM and the graphics card module are all 1.5V, the regular voltage VR may be 1.5V. The computer system 20 determines whether to enable the graphics card module according to the requirement of the running program, and generates a control signal CTL to control the control logic circuit 208. The control logic circuit 208 generates the enable signal EN according to the control signal CTL to indicate whether to provide the regular voltage VR to the second electronic device 202. For example, when the enable signal EN is a high voltage level, the regular voltage VR is provided to the second electronic device 202, and when the enable signal EN is a low voltage level, the regular voltage VR is not provided to the second electronic device 202, so as to turn on the graphics card module or turn off the graphics card module according to the requirement. In short, in the computer system 20, the voltage regulator 206 can provide the regular voltage VR to the first electronic device 200 and also can provide the regular voltage VR to the second electronic device 202 simultaneously. In comparison with the prior art, the present invention only requires the logic circuit 208 and the load switch circuit 210 to be able to output the regular voltage VR from the voltage regular 206 to the second electronic device 202, and does not configure an exclusive voltage regulator for the second electronic device 202. As a result, the present invention may reduce more power consumption and save the system cost.

In another embodiment of the present invention, the first electronic device 200 is the SO-DIMM using a Low-voltage Double-Data-Rate Three (DDR3L) specification and a related working voltage is 1.35V, and the second electronic device 202 is the graphics card module using the GDDR5 specification and a related working voltage is 1.5V. First, the voltage of the regular voltage VR provided by the voltage regulator 206 is 1.5V to meet the voltage specification of the graphics card module. Although the working voltage of the SO-DIMM is 1.35V, the working voltage also may be upwardly compatible with 1.5V. In such a situation, the single voltage regulator 206 also can be utilized to provide the regular voltage VR to the first electronic device 200 and the second electronic device 202 from the above described operating method, so as to achieve the purpose of the power supply.

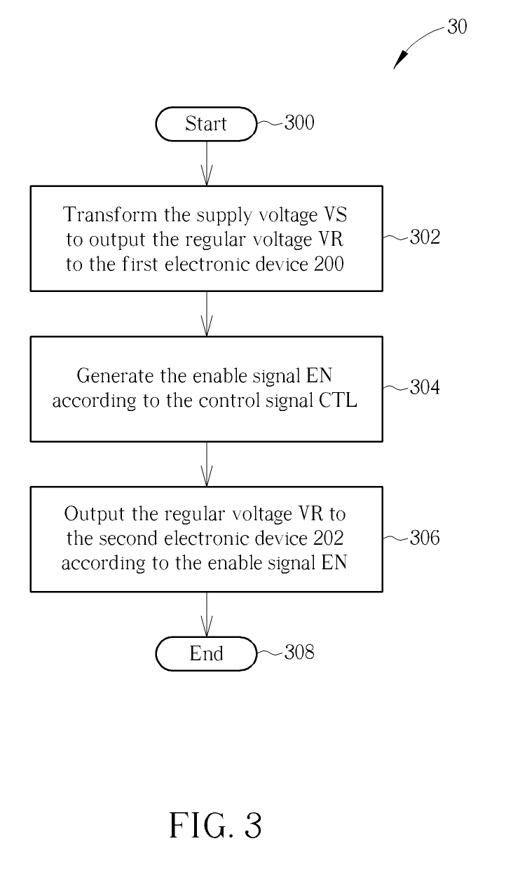

The operation of the power supply device 204 can be summarized as a power supply process 30. Please refer to FIG. 3, which illustrates a schematic diagram of the power supply process 30 according to an embodiment of the invention. The power supply process 30 includes the following steps:

Step 300: Start.

Step 302: Transform the supply voltage VS to output the regular voltage VR to the first electronic device 200.

Step 304: Generate the enable signal EN according to the control signal CTL.

Step 306: Output the regular voltage VR to the second electronic device 202 according to the enable signal EN.

Step 308: End.

According to the power supply process 30, the embodiment of the invention provides the regular voltage VR to the first electronic device 200 by the voltage regulator 206. Simultaneously, the embodiment of the invention selects whether to output the regular voltage VR to the second electronic device 202 by utilizing the load switch circuit 210 according to the enable signal EN. The detailed description and associated changes of the power supply process 30 may be referred to in the forgoing text, and will not be narrated hereinafter.

In summary, the prior art must individually configure an exclusive voltage regulator to provide the required power for each of the specific electronic device. In comparison, the present invention only requires the simple control logic circuit and load switch circuit, and is able to utilize the single voltage regulator to provide power to a plurality of electronic devices, without configuring an exclusive voltage regulator for every electronic device. As a result, the system cost may be effectively saved and the power consumption may be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system, comprising:
a first electronic device configured to be operated by utilizing a regular voltage;
a second electronic device configured to be operated by utilizing the regular voltage; and
a power supply device, for providing the regular voltage, comprising:
a voltage regulator, coupled to the first electronic device, for transforming a supply voltage to output the regular voltage to the first electronic device;
a control logic circuit, for generating an enable signal according to a control signal; and
a load switch circuit, coupled to the control logic circuit, the voltage regulator and the second electronic device, for outputting the regular voltage to the second electronic device according to the enable signal.

2. The computer system of claim 1, wherein the load switch circuit outputs the regular voltage to the second electronic device when the enable signal indicates to turn on the second electronic device.

3. The computer system of claim 1, wherein the load switch circuit does not provide the regular voltage to the second electronic device when the enable signal indicates to turn off the second electronic device.

4. The computer system of claim 1, wherein the first electronic device and the second electronic device are memory modules.

5. The computer system of claim 4, wherein the first electronic device is a Small Outline-Dual In-Line Memory Module (SO-DIMM) and the second electronic device is a Video Random Access Memory (VRAM) module.

6. A power supply device, for a computer system, comprising:
a voltage regulator, for transforming a supply voltage to output a regular voltage to a first electronic device of the computer system;
a control logic circuit, for generating an enable signal according to a control signal; and
a load switch circuit, coupled to the control logic circuit, the voltage regulator and a second electronic device of the computer system, for outputting the regular voltage to the second electronic device according to the enable signal.

7. The power supply device of claim 6, wherein the load switch circuit outputs the regular voltage to the second electronic device when the enable signal indicates to turn on the second electronic device.

8. The power supply device of claim 6, wherein the load switch circuit does not provide the regular voltage to the second electronic device when the enable signal indicates to turn off the second electronic device.

9. The power supply device of claim 6, wherein the first electronic device and the second electronic device are memory modules.

10. The power supply device of claim 9, wherein the first electronic device is a Small Outline-Dual In-Line Memory Module (SO-DIMM) and the second electronic device is a Video Random Access Memory (VRAM) module.

11. A power supply method for a computer system, wherein the computer system comprises a first electronic device and a second electronic device, comprising:
transforming a supply voltage to output a regular voltage to a first electronic device of the computer system;
generating an enable signal according to a control signal; and
outputting the regular voltage to the second electronic device according to the enable signal.

12. The power supply method of claim 11, wherein the regular voltage is outputted to the second electronic device when the enable signal indicates to turn on the second electronic device.

13. The power supply method of claim 11, wherein the regular voltage is not provided to the second electronic device when the enable signal indicates to turn off the second electronic device.

14. The power supply method of claim 11, wherein the first electronic device and the second electronic device are memory modules.

15. The power supply method of claim 14, wherein the first electronic device is a Small Outline-Dual In-Line Memory Module (SO-DIMM) and the second electronic device is a Video Random Access Memory (VRAM) module.
